(19) United States
(12) Patent Application Publication
(10) Pub. No.: US 2009/0313993 A1
(43) Pub. Date: Dec. 24, 2009

(54) VAPORIZER FOR A WASTE HEAT RECOVERY SYSTEM

(76) Inventors: Christian Bausch, Bubesheim (DE); Jens Grieser, Sohnstetten (DE); Jurgen Berger, Gerstetten (DE)

Correspondence Address: TAYLOR & AUST, P.C., P.O. Box 560, 142. S Main Street, Avilla, IN, 46710, US

(21) Appl. No.: 12/487,146

(22) Filed: Jun. 18, 2009

(30) Foreign Application Priority Data
Jun. 20, 2008 (DE) 102008029096.3-16

(51) Int. Cl. F02G 5/02; F28F 3/00

(52) U.S. Cl. 60/616; 165/166

(57) ABSTRACT

The invention relates to a vaporizer for a working medium for operating a vapor circulation process, including a working medium inlet section, a heat exchanger section, and a vapor collection section for the vaporized working medium, which are constructed as a stacking sequence from a plurality of materially bonded plates having through openings, a first channel system for conducting the heat transfer medium and a second channel system for conducting the working medium, which is hydraulically separated from the first channel system, being applied in the heat exchanger section, and the first channel system and the second channel system each being implemented by a partial overlap of the through openings of adjacent plates.

### BACKGROUND OF THE INVENTION

1. Field of the Invention

The invention relates to a vaporizer for a waste heat recovery system, in particular for the operation of a steam engine for the waste heat recovery of an internal combustion engine.

2. Description of the Related Art

Waste heat recovery systems use the waste heat of an internal combustion engine to vaporize a working medium, which then relaxes in an expander while generating mechanical power. Following the expander, the vapor phase of the working medium is condensed and supplied to the vaporizer again. Possible heat sources of an internal combustion engine for heating the vaporizer are the exhaust gas stream or the coolant stream. Further heat sources result through the exhaust gas recirculation and air cooling of vehicle engines and the intermediate cooling during multistage turbocharging. Alternatively or additionally, a separate burner unit may be provided.

Waste heat recovery systems may advantageously improve the overall efficiency of a drive by the at least partial use of the waste heat of an internal combustion engine. This advantage is opposed by the fact that the components of the steam engine increase the total weight of the vehicle and, furthermore, occupy additional installation space. Vaporizers as a component of a waste heat recovery system must therefore be efficient, have small constructions, and be adaptable to the particular application.

Vaporizers having a heating register including a pipe bundle are known. For a first design, the heat transfer medium flows around the outside walls of the pipe bundle. For a further design, hydraulically separate flow channel systems are provided for both the working medium and also the heat transfer medium. Reference is made for this purpose to GB 1084292 A, for example. A plate heat exchanger is disclosed in this publication, which is constructed from an alternately applied stacking sequence of two plate types. A first plate type conducts the heat transfer medium, and the second plate type conducts the working medium to be vaporized. The flow channels in the two plate types are applied as channels open on one side, which are each covered by the closed side of the adjacent plate. Such a configuration has the disadvantage that the structuring of the individual plates is connected to a high manufacturing effort. This is true in particular for the production of a multiply branched channel system in a plate, in order to cause the most turbulent possible conduction of the particular medium. Furthermore, the pattern of the flow channels used for the working medium to be vaporized must be adapted to the dimensioning of the waste heat recovery system and the thermal power introduction available for the particular application. This usually requires an individual pattern adaptation, which is in turn complex. Furthermore, high forces resulting from the vapor pressure are to be absorbed for the known plate vaporizers because of the expansion of the wall faces. Correspondingly heavy vaporizers having large constructions are the result of these high mechanical strains.

Furthermore, a vaporizer in the form of a plate stack is known from DE 19991048222, for which the flow channels for conducting the heat transfer medium and those for receiving the working medium are implemented having different cross-sections. The working medium channels advantageously have small cross-sections, in order to counteract the vapor film forming on the walls of the working medium channels, which undesirably decreases the heat transfer into the liquid phase (Leidenforst phenomenon). For this purpose, it is proposed that each two plate faces having fishbone-patterned channel structures be brought into planar contact. Intersecting channel structures for the plates pressing one against another are used for the flow channels for conducting the heat transfer medium, so that the largest possible free cross-section results. For the narrow working medium channels, a parallel configuration of interlocking structures is preferred for the vaporizer-side volume reduction. The design effort resulting therefrom is disadvantageous. Spacers are necessary in particular for the parallel configuration of the channels. Furthermore, the scalability and the individual cross-sectional adaptation and the desired channel widening to receive the vapor phase are only possible to an inadequate extent.

What is needed in the art is an improved vaporizer in a waste heat recovery system in regard to the heat transfer from the heat transfer medium, for example, the exhaust gas stream or a coolant stream, to the working medium. Furthermore, the vaporizer is distinguished by a small installation size and by improved scalability. The scalability is provided for the heat transfer stream, the throughput of working medium, and the volume stream in the vapor phase of the working medium. Furthermore, a simple adaptability of the vaporizer to a specific vehicle type is provided. Moreover, the vaporizer according to the invention is implemented as simple to design and manufacture.

### SUMMARY OF THE INVENTION

The present invention provides an improved vaporizer which may be constructed in the form of a stacking sequence of plates which are materially bonded to one another, and which each have through openings. The stacking sequence is applied so that the through openings applied in adjacent plates partially overlap one another and two separate channel systems having a meandering and branching course arise. Both the first channel system and also the second channel system preferably include a plurality of flow channels. The through openings are preferably situated so that a single flow channel of the first channel system is adjacent to a plurality of flow channels of the second channel system and intersects them.

The first channel system is used to conduct the heat transfer medium, for example, the exhaust gas stream of an internal combustion engine, into a heat exchanger section of the vaporizer. The second channel system conducts the working medium, which absorbs the thermal power in the heat exchanger section and vaporizes. Accordingly, at least in parts of the second channel system, in addition to the liquid working medium, its vapor phase exists, which exits into the vapor collection section of the vaporizer. The liquid phase of the working medium is supplied to the vaporizer through the working medium inlet section.

The second channel system is preferably applied so that the average flow direction in the heat exchanger section has a directional component in the stack direction. For the first channel system, for a preferred design, an average flow direction may be applied which runs transversely to the stack direction. As a result, the liquid working medium preferably enters through at least one through opening into the first plate of the stacking sequence, which is part of the working medium inlet section, and is removed as the vapor phase via at least one through opening in the last plate. In between, the heat exchanger section is traversed by the working medium channels. The heat transfer medium enters in the heat exchanger section on one front face of the stacking sequence and exits on the opposing front face.

The working medium inlet section, the heat exchanger section, and the vapor collection section are preferably coherent parts of the stacking sequence, so that the vaporizer forms a monolithic unit through the material bond of adjacent plates.

Through the selection of the plate sequence, and the configuration and shaping of the through openings in the plates, the flow channels of the first and second channel systems arise, which are hydraulically separated from one another. Especially preferably, an alternating plate sequence is used at least in the area of the heat exchanger section in which both the first channel and also the second channel exist. This is understood to mean that the through openings assigned to a channel system are essentially identical in shape and size from plate to plate, but they differ for adjacent plates in regard to their configuration relative to the edges of the plates and/or to a stop used for stacking the plates.

In this way, a transverse offset of the through openings arises in the stacking sequence of the plates, which results in meandering of the channels of the first and second channel systems. Furthermore, a plurality of branching points may be applied in the first and/or the second channel system, whereby a turbulent permeation having improved heat transfer is promoted.

Furthermore, it is conceivable to use only one type of plate for producing one of the sections of the vaporizer and to cause the desired transverse offset in the stacking sequence by an alternating protrusion of the plates at the edge. Furthermore, it is possible to construct the heat exchanger section in particular from more than two types of plates, both the configuration of the through openings and also their size and shape being able to be varied.

Power scaling may be caused for a vaporizer according to the invention in a simple way in that the plate number is changed in particular in the heat exchanger section and the vapor collection section. Because of a larger cross-section, an enlargement of the capacity of the flow channels, whose main transport direction runs essentially transverse to the plates, results for the heat exchanger section through the addition of further plates. For example, if the through openings for the first channel system are arrayed for each plate along a corresponding configuration direction and applied in regard to their size dimensioning so that the webs lying in the configuration direction between the through openings have a width which is less than the extension of the through openings in the configuration direction, a transverse offset may be used for the stacking sequence, for which a flow channel having multiple parallel flow paths arises. This channel has a sequence of branching individual channels, which each originate from a mixing chamber and open into such a chamber. Each of the mixing chambers represents a free volume which extends through the stacking sequence in the heat exchanger section. With each further plate, the number of the branches and the extension of the mixing chambers in the stack direction increases, so that a correspondingly higher volume stream of the heat transfer medium may pass through the vaporizer.

Accordingly, the vapor collection section may be adapted, by the addition of further plates in the stacking sequence or by the enlargement of the thickness of the plates used, to an enlarged vapor volume, in that the size of the vapor collection chambers is increased. Furthermore, the inflow of the working medium into the working medium inlet section is adaptable for the particular application by an adaptation of the free cross-sections, the dimensioning of the through openings, and the adaptation of the transverse offset of sequential plates.

The desired pattern of the through openings is especially preferably applied for the plates in a stainless steel sheet. Typical processing methods come into consideration for this purpose. In the case of sheet metal plates, a punching method or a laser beam cutting method may be applied. A soldering method is preferably employed for the material bonding of the plates of the stacking sequence, for which a soldering foil made of a nickel solder or a copper solder may be applied. In this way, a vaporizer according to the invention constructed as a stacking sequence results, which is designed for a pressure resistance of 70 bar, for example. Vaporizers according to the invention may be adapted to higher operating pressures by an enlargement of the web widths.

Furthermore, it is conceivable to use ceramic materials or high temperature plastics instead of metal materials for the plates or to provide the plates with a coating. The latter may improve the heat transfer through a surface enlargement or by influencing the turbulence formation for the permeation. Furthermore, coatings having a corrosion-inhibiting effect may be used. If exhaust gases of an internal combustion engine are used as the heat transfer medium, a coating may be provided for the first channel system which prevents deposits as a result of a catalytic action.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows the construction of a vaporizer according to the invention in an exploded illustration;

FIG. 2 shows an enlarged detail from FIG. 1, which illustrates the work medium inlet section and the heat exchanger section;

FIG. 3 shows an enlarged detail from FIG. 1, which illustrates the heat exchanger section and the vapor collection section;

FIG. 4 show the plate types used for the design according to FIGS. 1-3;

FIG. 5 shows the complete plate stack of a vaporizer according to the invention;

FIG. 6 shows a simplified example of a first plate of the vaporizer, which forms the heat exchanger section;

FIG. 7 shows a schematically simplified second plate of the vaporizer which forms the heat exchanger section;

FIG. 8 shows the superposition of the plates from FIGS. 6 and 7;

FIG. 9 shows a cross-sectional view along line A-A from FIG. 8;

FIG. 10 shows a cross-sectional view along line B-B from FIG. 8; and

FIG. 11 shows the cross-sectional view of the heat exchanger section from FIG. 10 supplemented by the sectional illustrations of the working medium inlet section and the vapor collection section.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

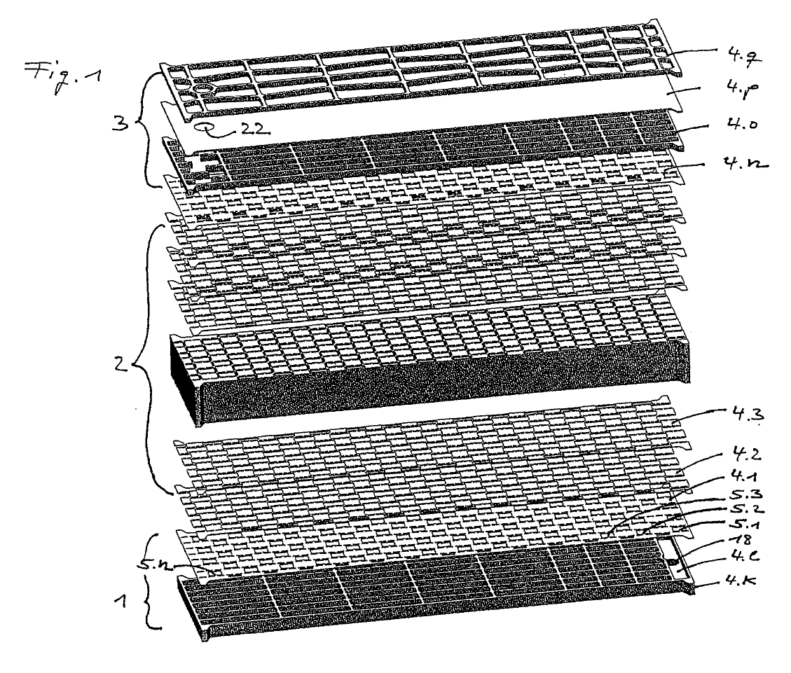

Referring now to the drawings, and more particularly to FIG. 1, there is shown an exploded illustration of the stacking sequence of the vaporizer according to the invention having the working medium inlet section 1, the heat exchanger section 2, and the vapor collection section 3 as the main components of the vaporizer. At least the heat exchanger section 2 includes a plurality of plates 4.1-4.n, which are materially bonded to one another and which each have through openings 5.1-5.n. In the present case, a passage in the particular plate face which generates a fluidic connection between the front face and the rear face of the plate is referred to as a through opening 5.1-5.n.

Through the selection of the size, the shape, and the configuration of the through openings 5.1-5.n and the relative positioning of adjacent plates 4.1-4.n transversely to the stacking direction, a first channel system 6 for conducting the heat transfer medium and a second channel system 7 for the liquid phase and the vapor phase of the working medium arise through a partial overlap of the through openings 5.1-5.n of sequential plates 4.1-4.n. Both the first channel system 6 and also the second channel system 7 may be divided into a plurality of individual flow channels, which each meander or branch depending on the selection of the pattern for the through opening.

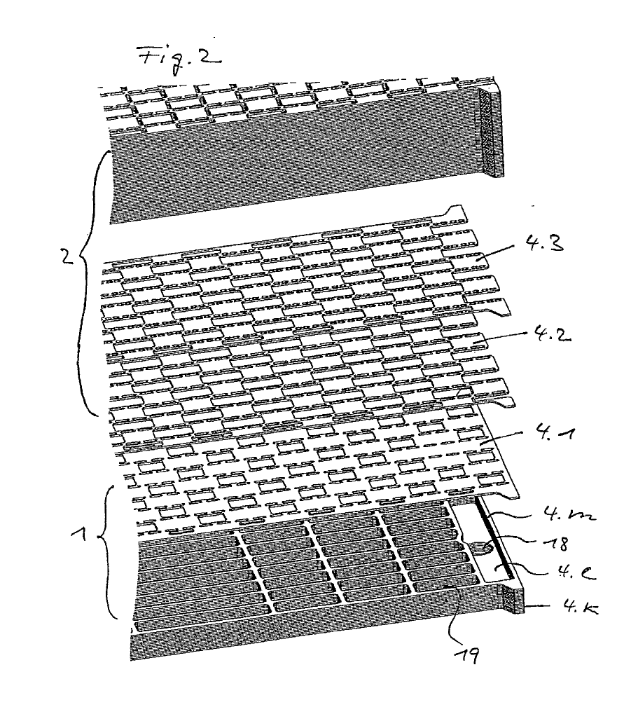

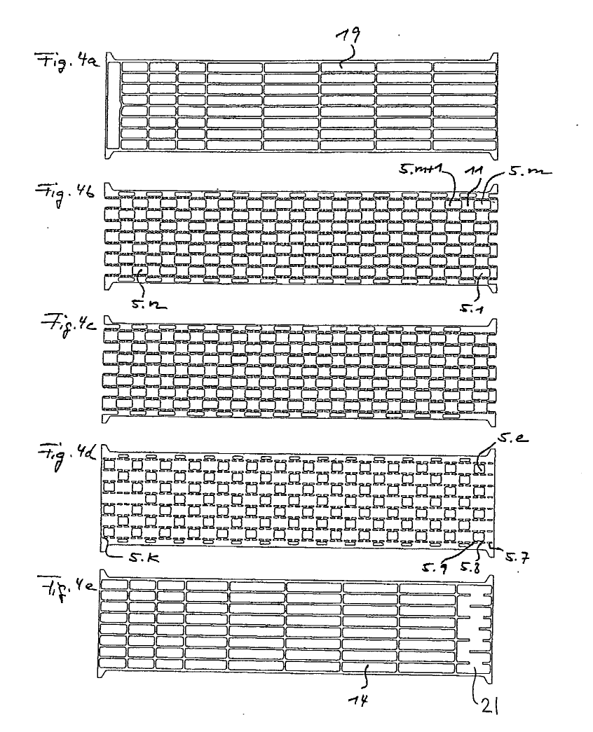

The working medium inlet section 1 constructed from the plate stack is obvious from the enlarged illustration of FIG. 2. It includes a plurality of plates of a first type 4.k, from which a support framework 20.1 arises on the exterior side of the vaporizer. This is not obvious in detail in FIG. 2, however, it is disclosed from the view of the completed vaporizer from FIG. 5. A horizontal projection of a vaporizer is shown from below, which has a working medium inlet 18 following the support framework 20.1. For a simplified design, the working medium inlet section 1 may have a single plate, which overlaps the through openings in the directly adjoining first plate of the heat exchanger section 2, which are assigned to the first channel system 7 for conducting the heat transfer medium.

The working medium inlet section 1 is terminated by a plate which is shown as a horizontal projection in FIG. 4d. The pattern of the smaller through openings, which is identified for exemplary purposes on the basis of the reference numerals 5.7, 5.8, 5.9-5.k, is used for the overflow of the work medium, which is supplied via the work medium inlet 18 to the work medium inlet section 1, into the individual work medium reservoirs 19. These through openings 5.7-5.k simultaneously represent the beginning of the work medium channels in the following heat exchanger section 2. A further type of through openings, identified in FIG. 4d for exemplary purposes by 5.1, is covered by the following plate of the heat exchanger section 2 in the stacking direction.

The plate identified by a 4.2 in FIG. 2 is shown as a horizontal projection in FIG. 4b. Between the through openings 5.m and 5.m+1, which are assigned to the first channel system 6 for conducting the heat transfer medium, a web 11 is provided, which covers the through openings 5.1 in the preceding plate 4.1 in the stacking sequence and thus hydraulically separates the first channel system 6 for the heat transfer medium from the second channel system 7 for the working medium.

An alternating sequence of the plate types shown in FIGS. 4b and 4c as horizontal projections is applied for the heat exchanger section 2. The two plate types have a transverse offset of the through opening 5.1-5.n which results in an overlap and the implementation, resulting therefrom, of the first channel system 6 and the second channel system 7. This is explained in greater detail hereafter on the basis of a simplified example.

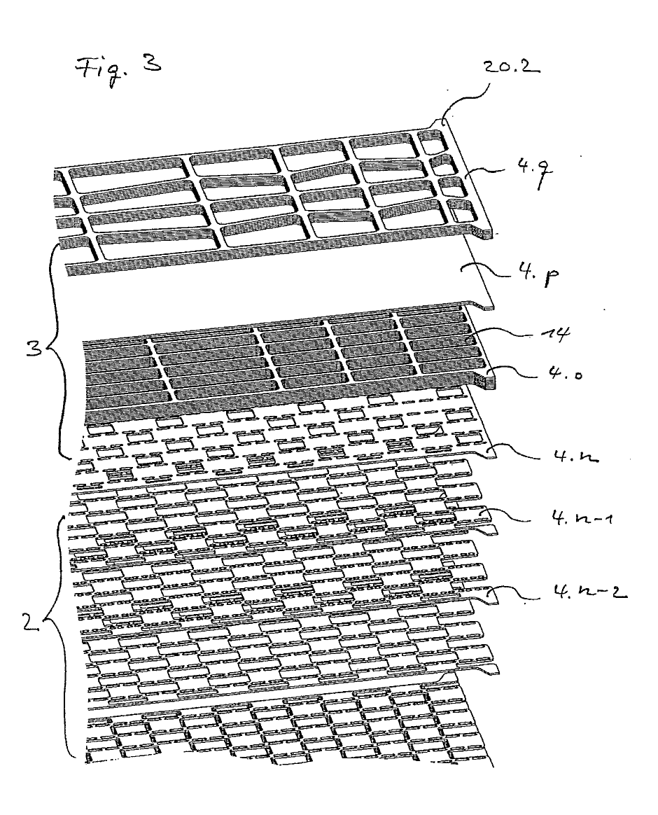

The upper end of the heat exchanger section 2 and the stacked construction of the following vapor collection section 3 are shown in FIG. 3. The construction of the plate 4.n-2 is shown in FIG. 4b and the plate 4.n-1 is structured correspondingly to FIG. 4c. The plate 4.n causes, because of a pattern of the through opening selected corresponding to FIG. 4d in connection with the preceding plate 4.n-1, covering of the first channel system 6 for conducting the heat transfer medium and thus a hydraulic separation from the second channel system 7, which is connected to the vapor collection section 3.

In the vapor collection section 3, at least one vapor collection chamber 14 is applied by a plate type, which is identified for exemplary purposes by the reference numeral 4.o, in which aligned, enlarged through openings are provided in each case. This is obvious from the horizontal projection of FIG. 4e. The individual vapor collection chambers 14 are hydraulically connected via through openings in the preceding or a following plate to a vapor outlet area 21. The vapor collection chambers 14 are covered by a continuous plate 4.p, which has a vapor outlet opening 22 according to the illustration in FIG. 1. The following plates in the stacking direction, one of which is identified for exemplary purposes by 4.q, again generate a supporting framework 20.2, in order to absorb the pressure forces on the exterior side of the vaporizer.

For a refinement of the invention which is not shown in detail, the free cross-section for the working medium channels of the second channel system 7 widens at least in the heat exchanger section 2. In this way, an adaptation to the volume enlargement because of the phase change of the working medium is performed. Corresponding to the function provided along a working medium channel in normal operation—preheating and vaporization of the liquid working medium and superheating of the vapor phase—the free flow cross-section is adapted. One possibility includes channel branching and increasing the parallel-guided working medium channels in the stacking direction. This is performed by a design of the overlap to implement the branching and an increase of the number of the through openings which are assigned to the second channel system 7. Alternatively, the free cross-section of the second channel system 7 may be set using an adaptation of the transverse dimensions of the individual working medium channels, which in turn is performed by a corresponding dimensioning of the through openings. Accordingly, enlarged through openings to implement the second channel system 7 are provided in the area in which the vaporization of the working medium begins in normal operation, and thereafter in the stacking direction.

Simple scaling of the vapor collection section is provided by an adaptation of the plate number and thus the adaptation of the volume of a vapor collection chamber 14. A performance adaptation of the heat exchanger 2 may be performed correspondingly by the selection of the plate number used for its construction. In addition, the transverse dimensions of the vapor collection chambers 14 may be established.

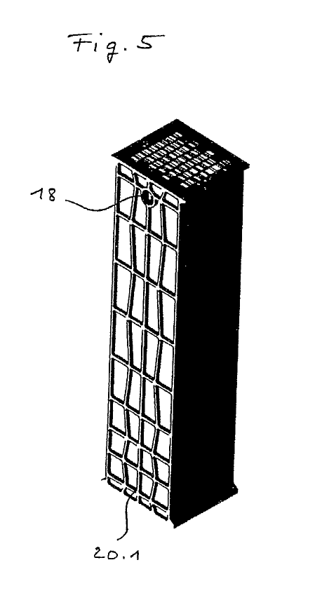

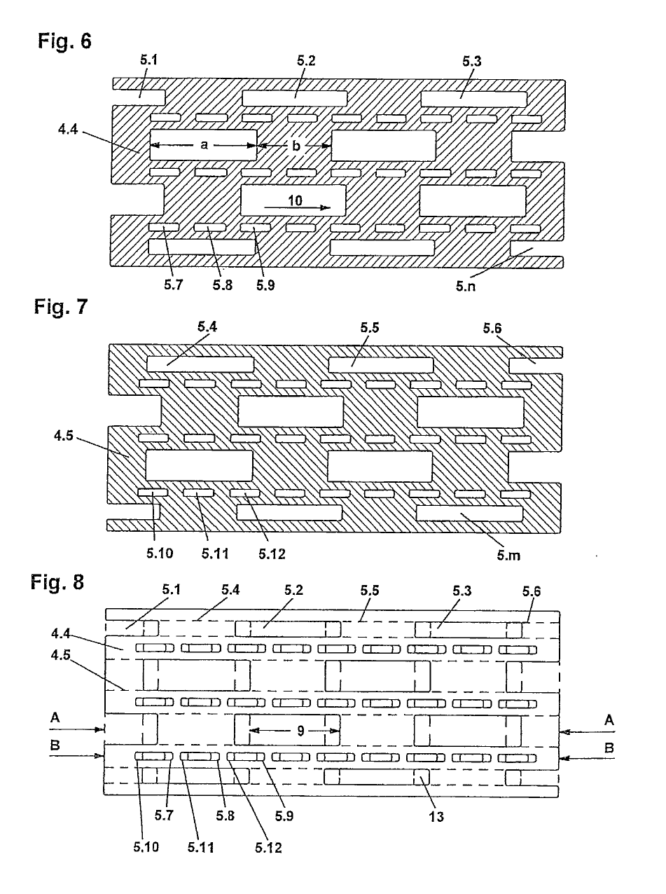

Furthermore, the possibility exists of adapting the free cross-section of the flow channels of the first channel system 6 by setting the transverse offset of the plates 4.1-4.n and/or the pattern of the through openings 5.1-5.n applied therein. For this purpose, the number of the branches 8 of the flow channels and the volume of mixing chambers 15 are established. This is explained for exemplary purposes hereafter on the basis of FIGS. 6-11.

FIG. 6 shows, for a simplified design example, a first plate 4.4 having a first pattern for the through openings 5.1-5.n. Through openings are identified for exemplary purposes by 5.1, 5.2, 5.3, which are assigned to the first channel system 6 for conducting the heat transfer medium, while through openings for the second channel system 7 for receiving the working medium are identified for exemplary purposes by 5.7, 5.8, 5.9. A configuration of the through openings 5.1-5.n is shown in the form of multiple lines running in parallel, which are each oriented in a predetermined configuration direction 10. In the present case, the configuration direction 10 runs longitudinally to a side edge of the plate 4.4.

FIG. 7 shows a horizontal projection of a further plate 4.5, which is situated adjacent to the plate 4.4 from FIG. 6 in the stacking sequence. The pattern of the through openings 5.4-5.m is provided with a transverse offset 9 in the configuration direction 10 in relation to the plate 4.1 shown in FIG. 6. Otherwise, the dimensioning of the through openings 5.1-5.n of the two plates 4.4 and 4.5 corresponds, so that with aligned, planar contact of the plates 4.4 and 4.5, which is shown in FIG. 8, a part of the first channel system 6 and the second channel system 7 results.

For the illustration in FIG. 8, the plate 4.4 from FIG. 6 is shown using solid lines, while the plate 4.5 from FIG. 7 is indicated as a dashed contour. It is obvious that the two patterns for the through openings 5.1-5.n partially overlap. The through openings 5.1, 5.2, and 5.3 of the plate 4.4 from FIG. 6, together with the through openings 5.4, 5.5, and 5.6 of the plate 4.5 from FIG. 7, form a single channel for the heat transfer medium, which is part of a flow channel of the first channel system 6. The through openings 5.7, 5.8, 5.9 of the plate 4.4 from FIG. 6 and the through openings 5.10, 5.11, 5.12 of the plate 4.5 from FIG. 7 form adjacent, separate parts of working medium channels 12 hydraulically separated therefrom.

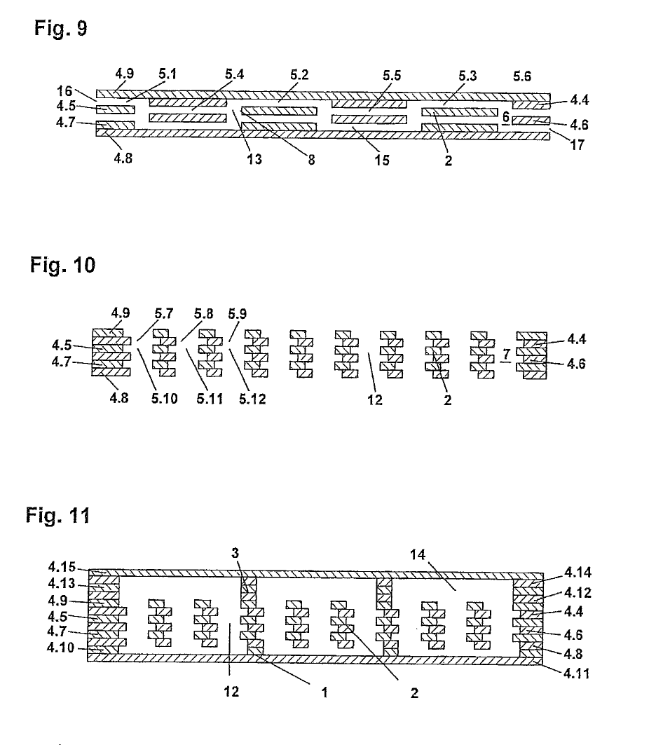

The flow channels of the first channel system 6 and the second channel system 7 resulting upon the superposition of the plates of the heat exchanger section 2 are illustrated for the present simplified example in the sectional views of FIGS. 9 and 10. FIG. 9 proceeds from a section A-A in FIG. 8, for the illustration, in addition to the plates 4.4 and 4.5, two further corresponding alternately applied plates 4.6 and 4.7 having been added and the adjoining plates 4.8 and 4.9 of the work medium inlet section 1 and the vapor collection section 3 being shown.

It is obvious from FIG. 9 that in the illustrated channel for the heat transfer medium 15, which is part of the first channel system 6, an inlet 16 is provided for the heat transfer medium on a first front face of the heat exchanger section 2 and an outlet 17 is provided for the heat transfer medium 17 on the opposing front face. A plurality of branches 8 is provided along the flow channel, which each originate from a mixing chamber 13 and open into such a mixing chamber. The illustrated structure of the flow channel arises through the dimensioning and configuration of the associated through openings. For exemplary purposes, the through openings 5.1, 5.4, 5.2, 5.5, 5.3, and 5.6 specified in FIGS. 6 and 7 are identified, which are arrayed in the specified sequence. It is obvious from FIG. 6 that, viewed in the configuration direction 10, the webs 11 between the through openings 5.1-5.n have a width b, which is less than the extension of the through openings a in the configuration direction 10. A flow path which continually branches and rejoins repeatedly in a mixing chamber 13 results through the selection of the transverse offset 9 as shown by the illustration of FIG. 9. It is closed in relation to the second channel system 7 using the plates 4.8 and 4.9.

A part of the second channel system 7 for the working medium is shown in FIG. 10 starting from section B-B from FIG. 8 for the plates 4.4 and 4.5 supplemented by the correspondingly alternately situated plates 4.6 and 4.7 and the adjoining plates 4.8 and 4.9 of the working medium inlet section 1 and the vapor collection section 3. It is obvious that multiple parallel, meandering working medium channels 12 are provided, which traverse the heat exchanger section 2 and which are situated adjacent and intersecting to the channel 15 shown in FIG. 9 for the heat transfer medium of the first channel system 6. For exemplary purposes, the through openings 5.7-5.12 identified in FIGS. 6 and 7 are specified.

Because of the adjacent and intersecting configuration of the working medium channels 12 and the channels 15 for the heat transfer medium, there is a good heat transfer coefficient from the heat transfer medium to the working medium. The working medium vaporizes in the working medium channels 12 of the second channel system 7 and enters in vapor form into the vapor collection chambers 14 in the vapor collection section 3.

In FIG. 11, the cross-sectional illustration from FIG. 10 is supplemented by additional plates 4.10-4.15, which complete the plate stack of the vaporizer. Each of the working medium channels 12 originates from the working medium inlet section 1. It is formed by the plates 4.8, 4.10, and 4.11 for the simplified design shown in the present case. The plates 4.4-4.7 of the heat exchanger section 2 having alternately situated through openings 5.1-5.n, which form a transverse offset, then follow. These are adjoined in the stacking direction by the plates 4.9, 4.12-4.15 of the vapor collection section 3.

Furthermore, it is obvious from FIG. 11 that the individual areas of the vaporizer may be adapted to the particular use by establishing the number of the plate stacked one on top of another and the through openings implemented therein. This relates to the flow cross-sections, the details of the flow conduction, the volume available for the vapor phase, and the relative location of the flow pathways of the first channel system 6 and the second channel system 7. It is possible to construct a vaporizer according to the invention from a limited number of different plates 4.1-4.n. In particular, the pattern of the through openings 5.1-5.n for sequential plates 4.1-4.n of the particular section may be repeated except for a transverse offset 9. For more complex applied flow channels, multiple different types of plates 4.1-4.n may form the stacking sequence of the vaporizer in varying sequence.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 working medium inlet section
2 heat exchanger section
3 vapor collection section
4.1-4.q plates
5.1-5.n through openings
6 first channel system
7 second channel system
8 branch
9 transverse offset
10 configuration direction
11 web
12 working medium channel
13 mixing chamber
14 vapor collection chamber
15 channel for heat transfer medium
16 inlet for the heat transfer medium
17 outlet for the transfer medium
18 working medium inlet
19 working medium reservoir
20.1, 20.2 support framework
21 vapor outlet area
22 vapor outlet opening
a extension of the through opening in the configuration direction
b width of a web

What is claimed is:

1. A vaporizer for a working medium for operating a vapor circulation process, said vaporizer comprising:
a working medium inlet section;
a heat exchanger section, said heat exchanger section including a first channel system and a second channel system which is hydraulically separated from said first channel system, said first channel system configured for conducting a heat transfer medium, said second channel system configured for conducting said working medium; and
a vapor collection section for a vaporized said working medium, said working medium inlet section, said heat exchanger section, and said vapor collection section being constructed as a stacking sequence from a plurality of materially bonded plates which have a plurality of through openings, said first channel system and said second channel system being formed by a partial overlap of said plurality of through openings of adjacent ones of said plurality of materially bonded plates.

2. The vaporizer according to claim 1, wherein said first channel system and said second channel system each include a plurality of meandering flow channels, said first channel system conducting said heat transfer medium in said heat exchanger section essentially transversely to said plurality of materially bonded plates, said second channel system conducting said working medium from said working medium inlet section to said vapor collection section through said plurality of materially bonded plates of said heat exchanger section.

3. The vaporizer according to claim 2, wherein at least one of said first channel system and said second channel system have a plurality of branches which are formed by a transverse offset of said plurality of through openings in said plurality of materially bonded plates of said heat exchanger section.

4. The vaporizer according to claim 3, wherein said heat exchanger section includes at least two types of said plurality of materially bonded plates which differ in regard to a configuration of said plurality of through openings.

5. The vaporizer according to claim 4, wherein said stacking sequence of said plurality of materially bonded plates of said heat exchanger section has an alternating said transverse offset.

6. The vaporizer according to claim 1, wherein said plurality of materially bonded plates forming said heat exchanger section have at least respective ones of said plurality of through openings, which are arrayed along a predetermined configuration direction, and have a plurality of intermediate webs, a plurality of widths of said plurality of intermediate webs being less than an extension of said respective ones of said plurality of through openings of said heat exchanger section in said configuration direction.

7. The vaporizer according to claim 1, wherein said second channel system includes a plurality of working medium channels, said plurality of working medium channels of said second channel system in said heat exchanger section for conducting said working medium opening into a mixing chamber, which is formed by at least one of said plurality of through openings in a respective one of said plurality of materially bonded plates, which is part of said vapor collection section.

8. The vaporizer according to claim 7, wherein a volume of said mixing chamber is established by a thickness and a number of said plurality of materially bonded plates which are stacked on one another, which form said vapor collection section, and which have respective ones of said plurality of through openings which align with one another.

9. The vaporizer according to claim 1, wherein a free cross-section in said second channel system for conducting said working medium increases in said heat exchanger section.

10. The vaporizer according to claim 1, wherein a free cross-section in said second channel system for conducting said working medium is adapted to a local assignment provided in a normal operation for a preheating, a vaporization, and a superheating of said working medium.

11. The vaporizer according to claim 1, wherein said plurality of materially bonded plates are sheet-metal plates.

12. The vaporizer according to claim 11, wherein said plurality of materially bonded plates are made of stainless steel.

13. The vaporizer according to claim 11, wherein a solder bond forms a material bond of said plurality of materially bonded plates.

14. The vaporizer according to claim 13, wherein said solder bond is one of a nickel solder and a copper solder.

15. The vaporizer according to claim 1, wherein said first and said second channel systems include a plurality of walls, at least a part of said plurality of walls of at least one of said first channel system and said second channel system includes a coating.
